(19) United States
(12) Patent Application Publication
(10) Pub. No.: US 2020/0311446 A1
(43) Pub. Date: Oct. 1, 2020

(54) ABNORMALITY DETERMINATION DEVICE

(71) Applicant: Nomura Research Institute, Ltd., Tokyo (JP)

(72) Inventor: Akifumi NAKADA, Tokyo (JP)

(21) Appl. No.: 16/826,769

(22) Filed: Mar. 23, 2020

(30) Foreign Application Priority Data
Mar. 25, 2019 (JP) 2019-055842

(51) Int. Cl. G06K 9/00; G06T 7/246

(52) U.S. Cl. CPC G06K 9/00825; G06T 7/248

(57) ABSTRACT

An abnormality determination device obtains a moving image of a monitored area from a camera. The abnormality determination device extracts, from the moving image, a plurality of still images that continues with time and identifies an object (automobile) that moves or changes with reference to the plurality of still images. The abnormality determination device analyzes operation modes of a plurality of objects to determine whether an abnormal event such as dangerous driving occurs, and warns an automobile and so on when detecting the dangerous driving.

### BACKGROUND

### Technical Field

The present invention relates to a technology for detecting the occurrence of abnormality.

### Related Art

The accuracy of image recognition in various situations, e.g., recognizing what is in an image or recognizing whether an image A and an image B are similar to each other, has recently been improved due to artificial intelligence-related technologies such as deep learning. For example, JP 2009-284332 A discloses a technology for automatically selecting, from among a multiple of images, an image that a viewer is interested in.

### SUMMARY

Moving images from a surveillance camera can be evidence of traffic violations or crimes in many cases. In the present situation, however, a person often sees such a moving image in real time or analyzes such a moving image afterward, which means that the image recognition technology for moving images is still in a development stage.

The present invention has been made on the basis of the foregoing recognition of the present inventor, and a primary object of an embodiment of the present invention is to provide a technology for early detecting the occurrence of an abnormal event by analyzing a moving image.

According to an aspect of the present invention, there is provided an abnormality determination device including an imaging unit configured to capture a moving image, an image recognition unit configured to extract, from the moving image, a plurality of still images that continues with time and identify an object that moves or changes with reference to the plurality of still images, an abnormality determination unit configured to determine whether an abnormal condition is satisfied on the basis of an operation mode of the identified object, and a notifying unit configured to notify an external device of occurrence of abnormality when the abnormal condition is satisfied.

According to the present invention, the occurrence of an abnormal event is easy to be detected early on the basis of a moving image.

### BRIEF DESCRIPTION OF DRAWINGS

FIG. 1 is a schematic diagram for a case where an abnormality determination system shoots a moving image;

FIGS. 2A to 2D are conceptual diagrams of steps of a moving image analysis;

FIG. 3 is a functional block diagram of an abnormality determination device;

FIG. 4 is a conceptual diagram of an abnormality determination model; and

FIG. 5 is a flowchart depicting steps of processing at the time of abnormality determination.

### DETAILED DESCRIPTION

In the present embodiment, cameras installed throughout the city are used to observe roads at fixed points, and automatic determination as to whether “dangerous driving” occurs is made on the basis of moving images obtained by the fixed-point observation. The dangerous driving means abnormal driving that can lead to violations of traffic laws or traffic accidents, e.g., speeding, wrong-way driving, tailgating, or erratic driving. In the present embodiment, particularly, “tailgating” is described as an example of the dangerous driving. The tailgating means that the following vehicle drives too closely to the leading vehicle while not leaving sufficient distance from the leading vehicle, means that the following vehicle follows the leading vehicle for a long time, or the like.

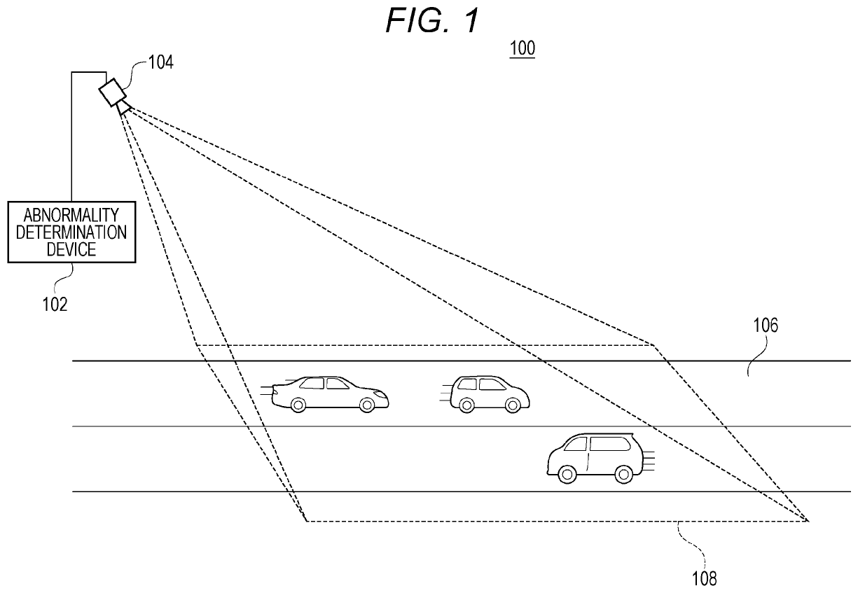

FIG. 1 is a schematic diagram for a case where an abnormality determination system 100 shoots a moving image.

A camera 104 is fixed above a road 106 to take an image of a part of the road 106 from an elevated viewpoint. A plurality of such cameras 104 is installed in the road 106.

A multiple of automobiles passes through a monitored area 108 that is an imaging range of the camera 104. An abnormality determination device 102 identifies the shape, position, direction, speed, acceleration, and so on of each automobile from a moving image. The abnormality determination device 102 analyzes the moving image to determine whether dangerous driving (tailgating in the present embodiment) occurs on the road 106. The abnormality determination device 102 may be connected to the plurality of cameras 104; however, in the present embodiment, the description is provided by taking an example in which one abnormality determination device 102 is connected to one camera 104. When detecting dangerous driving, the abnormality determination device 102 sends a message to the corresponding vehicle.

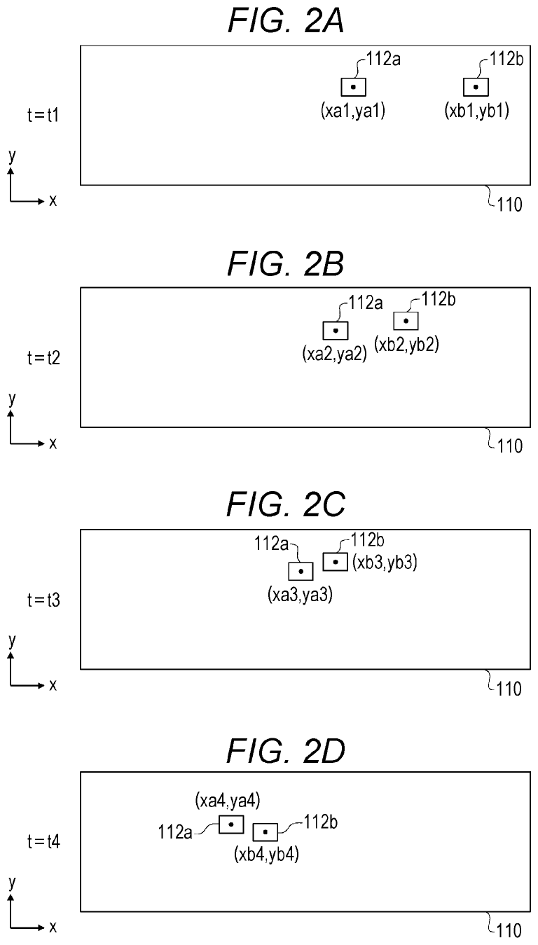

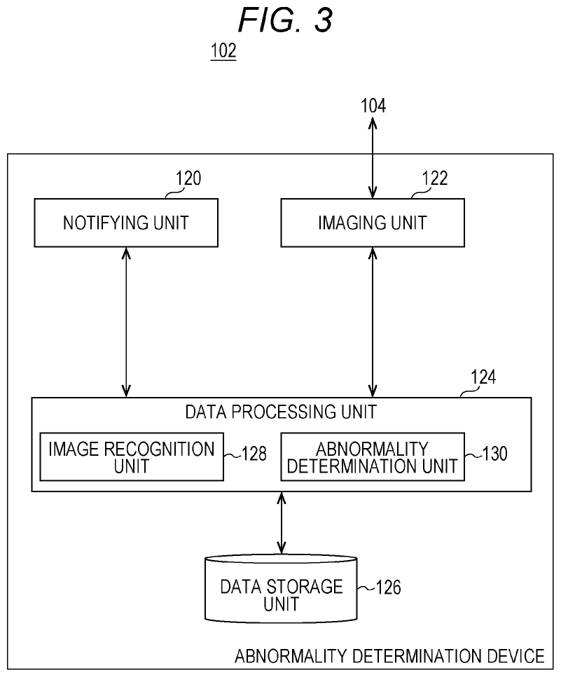

FIGS. 2A to 2D are conceptual diagrams of steps of a moving image analysis.

As described above, the camera 104 observes the monitored area 108 at a fixed point. A plurality of still images is picked up in chronological order from the moving image at this time. All of the still images constituting the moving image may be picked up or the still images may be picked up selectively at the rate of one image per several images.

Out of the still images, a part corresponding to an automobile is identified as an “object”. Image processing is applied to the still image to obtain an image in which the shape, position, direction of the object is identified. The image obtained is referred to as a processed image 110.

FIG. 2A shows the processed image 110 at time t1. FIG. 2B shows the processed image 110 at time t2, FIG. 2C shows the processed image 110 at time t3, and FIG. 2D shows the processed image 110 at time t4.

In the still image at time t1 (FIG. 2A), the abnormality determination device 102 detects two automobiles and identifies the two automobiles as an object 112a and an object 112b. Position coordinates of the object 112a in the processed image 110 are (xa1, ya1), and position coordinates of the object 112b in the processed image 110 are (xb1, yb1). The processed image 110 corresponds to the monitored area 108.

In the still image at time t2 (FIG. 2B), position coordinates of the object 112a are (xa2, ya2), and position coordinates of the object 112b are (xb2, yb2). From the two processed images 110 at time t1 and time t2, the abnormality determination device 102 recognizes that both the object 112a and the object 112b move in the negative direction of the x-axis and the object 112a is the leading vehicle and the object 112b is the following vehicle.

In the still image at time t3 (FIG. 2C), the object 112b (the following vehicle) approaches the object 112a (the leading vehicle) and the object 112b (the following vehicle) moves to the right side of the object 112a (the leading vehicle). The situation suggests that the object 112b (the following vehicle) drives too closely to the object 112a (the leading vehicle) from behind.

In the still image at time t4 (FIG. 2D), the object 112b (the following vehicle) is at the left rear of the object 112a (the leading vehicle) while approaching the object 112a (the leading vehicle). In general, determination as to whether driving corresponds to “tailgating” is probably made on the basis of how far the following vehicle is shifted from the two extension lines that represent both sides of the leading vehicle, a distance between the leading vehicle and the following vehicle, speed of the leading vehicle, relative speed, frequency of lateral movements of the following vehicle, and so on.

The abnormality determination device 102 identifies an automobile on the basis of the license plate, shape, and color of the automobile, and gives an ID (hereinafter, called an “object ID”) to the object 112 corresponding to the automobile. In a case where the automobile can send an ID signal all the time, the abnormality determination device 102 may identify the automobile on the basis of the ID signal. The abnormality determination device 102 detects coordinates of the central point of the object 112 as position coordinates of the object 112.

It is possible to detect, as the position coordinates of the object 112, position coordinates of a representative point such as the central point or the center of gravity of the object 112 (predetermined area of the processed image 110), or, alternatively, as the position coordinates of the object 112, position coordinates of a plurality of points (group) included in the object 112. For example, it is possible to detect, as the position coordinates of the object 112, position coordinates of each pixel (group) included in the predetermined area of the object 112 of the processed image 110 or, alternatively, as the position coordinates of the object 112, position coordinates of each pixel (group) sampled at regular intervals from the predetermined area.

FIG. 3 is a functional block diagram of the abnormality determination device 102.

Each constituent element of the abnormality determination device 102 is implemented by an arithmetical unit such as a central processing unit (CPU) and each type of coprocessor, a storage device such as a memory or storage, hardware including a wired or wireless communication line for connecting the constituent elements to each other, and software that is stored in the storage device and gives processing instructions to the arithmetical unit. Computer programs may include a device driver, an operating system, various application programs in a layer thereabove, or, may include a library to provide these programs with a common function. Each of the blocks described below is a block on a function-by-function basis not on a hardware-by-hardware basis.

The abnormality determination device 102 includes a notifying unit 120, an imaging unit 122, a data processing unit 124, and a data storage unit 126.

The notifying unit 120 serves to notify, when an abnormal condition described below is satisfied, an external device such as an automobile of the occurrence of abnormality (to the effect that dangerous driving is applicable). The imaging unit 122 obtains a moving image from the camera 104 all the time. The data storage unit 126 stores, therein, various types of data including the computer programs. The data processing unit 124 executes different types of processing on the basis of data obtained from the imaging unit 122 and the data storage unit 126. The data processing unit 124 functions also as an interface between the notifying unit 120, the imaging unit 122, and the data storage unit 126.

The data processing unit 124 includes an image recognition unit 128 and an abnormality determination unit 130.

The image recognition unit 128 obtains a moving image from the imaging unit 122 to extract still images arranged in a chronological order. The image recognition unit 128 also identifies the object 112 from the still image, detects the shape, position, and direction thereof to generate a processed image 110. More specifically, the image recognition unit 128 identifies, as the object 112 (moving object), an object that has characteristics of an automobile and moves or changes in shape in the plurality of still images. Further, the image recognition unit 128 gives the object 112 an object ID. The abnormality determination unit 130 determines whether the abnormal condition is satisfied on the basis of the moving image (described below). The abnormal condition in the present embodiment is to detect “dangerous driving”. The abnormality determination unit 130 analyzes the moving image by using an abnormality determination model 140 to determine whether dangerous driving such as tailgating occurs.

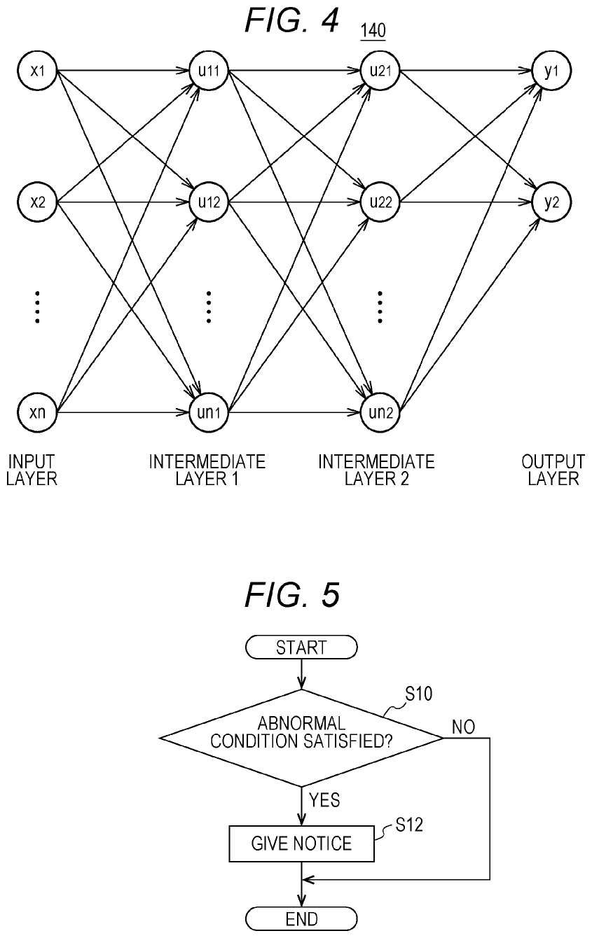

FIG. 4 is a conceptual diagram of the abnormality determination model 140.

The abnormality determination model 140 of the present embodiment is formed by a neural network. The abnormality determination model 140 of FIG. 4 includes an input layer, an output layer, and two intermediate layers 1 and 2, and the number of intermediate layers is any number. The abnormality determination model 140 is prepared for each type of the dangerous driving. The abnormality determination model 140 of FIG. 4 is described as a model for determining whether the dangerous driving corresponds to “tailgating”. The abnormality determination model 140 is used for determination as to whether “tailgating” occurs for each combination of two objects 112 identified in the processed image 110. For example, in the case where the object 112a, the object 112b, and an object 112c are detected, determination as to whether “tailgating” occurs is made for each of three combinations of the object 112a and the object 112b, the object 112a and the object 112c, and the object 112b and the object 112c.

The input layer includes n nodes (hereinafter, each also called an “input node”). The input node is denoted by “x”. The intermediate layer 1 includes n1 nodes (hereinafter, each also called a “first intermediate node”). The first intermediate node is denoted by “u1”. The intermediate layer 2 includes n2 nodes (hereinafter, each also called a “second intermediate node”). The second intermediate node is denoted by “u2”.

The output layer includes two nodes (hereinafter, each also called an “output node”). The output node is denoted by “y”. The output node y1 corresponds to false (that means not corresponding to “tailgating”) while the output node y2 corresponds to true (that means corresponding to “tailgating”). In the case where an output value of the output node y1 (false) is positive and an output value of the output node y2 (true) is negative, the possibility of tailgating is determined to be low. In the case where an output value of the output node y1 (false) is negative and an output value of the output node y2 (true) is positive, the “abnormal condition” is satisfied and the possibility of tailgating is determined to be high.

The input node x corresponds to an input item. For example, in order to determine whether “tailgating” occurs between the object 112a and the object 112b, the speed, position, vehicle direction of the object 112a at time t1, time t2, time t3, and time t4, and the speed, position, vehicle direction of the object 112b at time t1, time t2, time t3, and time t4 are inputted. Further, the relative speed of the object 112a and the object 112a, and a distance between the object 112a and the object 112a at time t1, time t2, time t3, and time t4 are also inputted.

The strength of connections between nodes (degree of connectivity) is represented by a “weighting factor”. The activation function f(x) of each node is represented by a known function such as rectified linear unit (ReLU) function. For example, the first intermediate node u11 obtains input values from a total of n nodes of input nodes x1 to xn. The ReLU function of the first intermediate node u11 obtains, as the input value x, a total value of the n input values. The ReLU function f(x) is a linear function where f(x)=x when x≥0 and f(x)=0 when x<0.

Eventually, the output value can be expressed as cumulative of degrees of influence of the input items 1 to n.

An operator of the abnormality determination device 102 inputs, in advance, a large amount of moving images including both a moving image corresponding to tailgating and a moving image not corresponding to tailgating to the abnormality determination model 140, and inputs whether each of the moving images corresponds to tailgating. The abnormality determination model 140 performs “supervised learning” by such a control method and learns the criteria for determining tailgating.

FIG. 5 is a flowchart depicting steps of processing at the time of abnormality determination.

The image recognition unit 128 extracts various input values from moving images obtained from the camera 104 and input the input values to the abnormality determination model 140. The abnormality determination unit 130 determines whether the abnormal condition is satisfied by using the abnormality determination model 140. If the abnormal condition is satisfied (Y in step S10), then the abnormality determination model 140 sends, to the following vehicle (object 112b of FIGS. 2A to 2D), a message such as that “keep a little more distance between cars” via a directional wireless communication (step S12). It is supposed that the following vehicle corresponding to the object 112b has a function to display, in response to the message received, the message in a display visible to a driver of the following vehicle. If the abnormal condition is not satisfied (N in step S10), then no message is sent.

The transmission destination of the message at the time when the abnormal condition is satisfied is not limited to the driver, and may be an observer such as police. When the abnormal condition is satisfied, the notifying unit 120 may send a control signal to the following vehicle driving dangerously. It is possible that when receiving the control signal, the following vehicle is forcibly controlled to slow down, stop on the shoulder, and so on.

The abnormality determination system 100 is described above on the basis of the embodiment.

According to the present embodiment, analyzing a moving image enables various “abnormal events” to be detected early and automatically. For this reason, in addition to verification after the occurrence of traffic violations or accidents, it is possible to early detect dangerous driving that could lead to an accident and to prevent such dangerous driving. In particular, as for “tailgating”, it is necessary to determine whether dangerous driving corresponds to tailgating on the basis of the relationship between a plurality of automobiles. In the present embodiment, not only parameters (position, speed, and so on) of two automobiles in the processed image 110 but a relative positional relationship between the two automobiles (distance between the automobiles, etc.) are used as input values, which enables determination of an abnormal event such as tailgating on the basis of relationship between the plurality of objects 112.

Autonomous vehicles are expected to become widespread in the future. While it is important for autonomous vehicles to become intelligent, a function becomes probably necessary for forcing the autonomous vehicles to stop from outside, if necessary. According to the abnormality determination system 100 of the present embodiment, it is possible to forestall an accident by early detecting not only an automobile driving dangerously but also an automobile operating abnormally on the basis of image analysis and sending a control signal for giving a command to stop or decelerate to the corresponding vehicle.

In the present embodiment, the abnormality determination model 140 is caused to learn moving images for tailgating through supervised learning. This makes the abnormality determination model 140 easily recognize different types of tailgating.

The present invention is not limited to the foregoing embodiment and modifications, and can be embodied by modifying the constituent elements without departing from the gist. Various inventions may be made by appropriately combining the plurality of constituent elements disclosed in the foregoing embodiment and modifications. Further, some constituent elements may be removed from all the constituent elements shown in the foregoing embodiment and modifications.

### [Modification]

In the present embodiment, the description is provided in which the abnormality determination model 140 based on multi-layer neural network (deep learning) is used to determine whether tailgating occurs. As a modification, it is possible to determine whether tailgating occurs on the basis of a difference between a plurality of still images of the moving images. To be specific, the image recognition unit 128 refers to the processed images 110 of FIGS. 2A to 2D and recognizes that the object 112a and the object 112b run in the same direction and the object 112a and the object 112b correspond to the leading vehicle and the following vehicle, respectively. The comparison between the processed image 110 at time t1 (FIG. 2A) and the processed image 110 at time t2 (FIG. 2B) shows that the object 112b (the following vehicle) moves to the right of the object 112a (the leading vehicle). The comparison between the processed image 110 at time t3 (FIG. 2C) and the processed image 110 at time t4 (FIG. 2D) shows that the object 112b (the following vehicle) moves to the left of the object 112a (the leading vehicle). The abnormality determination unit 130 determines that an abnormal condition of “tailgating” is satisfied if the following vehicle moves, by a predetermined value or more, to the right of the leading vehicle and also moves, by a predetermined value or more, to the left of the leading vehicle. Such a control method enables easy and speedy determination of the occurrence of “tailgating”.

In the present embodiment, “tailgating” is described as an example of the dangerous driving. In addition, different types of the abnormality determination model 140 may be prepared for determination of “wrong-way driving” and “speeding”. In the case of determination of wrong-way driving, it is possible to preset, on a rule-by-rule basis, an abnormal condition for determining wrong-way driving, such as an abnormal condition that “an automobile “a” drives to the right on a road lane where automobiles should drive to the left”. In the case of determination of speeding, an estimated speed is calculated on the basis of position coordinates of an automobile in a plurality of processed images 110, and if the estimated speed is above the prescribed speed, then the abnormality determination unit 130 may determine that the automobile drives faster than the speed limit (speeding).

Another method is possible in which global positioning system (GPS) is used to check speed and travelling direction of each automobile, then to detect speeding or wrong-way driving.

Other than those described above, determination for drunk driving or drowsy driving is possible. For example, the abnormality determination model 140 is caused to learn moving images for drunk driving, which enables the abnormality determination model 140 to learn in what way an automobile moves peculiar to drunk driving (for example, weaving: the pattern of lateral movement of an automobile). The abnormality determination model 140 which has learned in this way is capable of early detecting an automobile suspected of drunk driving. When an automobile suspected of drunk driving is detected, the notifying unit 120 informs police of the fact, which leads to prevention of a traffic accident related to drunk driving.

Providing an alcohol concentration detector in an automobile probably leads to reliable determination of drunk driving. When detecting the odor of alcohol in the automobile, the alcohol concentration detector sends an alcohol detection signal to an external device such as the abnormality determination device 102. However, even when the odor of alcohol is detected, it is possible that the driver is not intoxicated and a passenger is intoxicated. In view of this, when an alcohol detection signal is sent and further the abnormality determination device 102 detects suspicion of drunk driving on the basis of driving conditions of the automobile, the abnormality determination device 102 may send a control signal to force the corresponding automobile to stop temporarily and so on due to suspected drunk driving.

In addition, detection of ignoring traffic lights is also possible. For example, if the traffic light turns red at an intersection and an automobile is detected which enters the intersection at a speed faster than the speed limit, then it may be detected that the red light is ignored.

In the present embodiment, the description is provided in which the notifying unit 120 sends a message to an automobile. As a modification thereof, the notifying unit 120 may inform the police of an object ID of a vehicle driving dangerously. The police may be provided with communication means used for the object ID. Then, the police may directly inform the corresponding vehicle of a message with voice or the like.

When a vehicle driving dangerously is detected, the image recognition unit 128 of the abnormality determination device 102 may make a record of a license plate, type, and so on of the vehicle. A database in which feature information of automobiles are registered may be prepared, and the abnormality determination device 102 may identify the automobile driving dangerously on the basis of detected information. Suppose that the abnormality determination device 102 detects dangerous driving of an automobile C1 at a point P1. When the automobile C1 is detected again at a point P2, the abnormality determination device 102 may inform an external device operated by the police or the like that “the automobile C1 which has driven dangerously at the point P1 is present at the point P2”. According to this control method, the abnormality determination device 102 makes a record of features of the automobile that has driven dangerously and can inform, in response to redetection of the automobile having similar features by other cameras 104, the truth, which makes it easy to trace the vehicle driving dangerously.

The abnormality determination device 102 may be connected to a plurality of cameras 104. Suppose that the abnormality determination device 102 recognizes the occurrence of dangerous driving of an automobile C2 on the basis of moving images from a camera 104a. At this time, the image recognition unit 128 makes a record of feature information of the automobile C2 driving dangerously. Next, when a camera 104b detects the automobile C2 corresponding to the feature information, the abnormality determination device 102 determines whether the automobile C2 continues the dangerous driving. The abnormality determination unit 130 of the abnormality determination device 102 may determine that the abnormal condition is satisfied when an automobile determined to drive dangerously m times (n m 2) or more is recognized in the monitored area 108 of n (n 2) cameras 104. According to such a control method, dangerous driving can be determined more reliably as compared to the case of determination of dangerous driving by using only moving images of a single monitored area 108. Further, the camera 104a marks the automobile C2 suspected of dangerous driving, and other cameras 104b and 104c make abnormality determination preferentially on the automobile C2 among a multiple of automobiles on the basis of the abnormality determination model 140, resulting in early determination of dangerous driving.

The present embodiment has been described by taking an example of dangerous driving of an automobile; however, the technology for automatically detecting various events on the basis of moving images is applicable to various situations.

(1) Water Accidents

The camera 104 may be installed at a location where fixed-point observation of a swimming pool or beach can be made. The abnormality determination device 102 may detect a drowning person in a moving image at real time. Specifically, it may be determined that a person possibly drowns if conditions such as waving wildly, struggling on the surface of the water and submerging repeatedly, and hands separating from a rubber swimming ring which had been grabbed by hands are satisfied.

(2) Shark Approach

In recent years, there have been many incidents in which swimmers are attacked by sharks on beaches overseas. The abnormality determination device 102 may detect dorsal fin movement of a shark and call attention of swimmers by blowing a siren or the like in response to approach of the shark.

(3) Early Detection of Tsunami Signs

Images of the coast and offshore may be captured with artificial satellites or the like to detect the possibility of tsunami on the basis of the state of rising and falling of waves.

(4) Detection of Possibility of Landslides

Mountains and cliffs may be observed at fixed points to detect the possibility of debris flows from cracks in bedrock and falling rocks. It is often too late when people notice a debris flow. Detection of landform change in mountains enables early evacuation before a debris flow occurs. The same applies to avalanches.

(5) Detection of Meteorites and Other Falling Objects

Space is observed by artificial satellites. The fall of a meteorite or satellite into the earth may be detected to notify the ground system of the truth.

(6) Early Detection of Military Threats

Moving images from artificial satellites may be used to detect the approach of ballistic missiles from other countries, violation of territorial airspace, violation of territorial waters, illegal landings on islands, and so on.

(7) The Flow of People on the Street

The movement of not only automobiles but people may be detected by fixed-point observation by the camera 104. For example, stalking, fight, molester, line of people waiting to enter a shop, and so on can be detected.

(8) Wild Bird Counting

The number of wild birds and other species can be counted by fixed-point observation of the camera 104.

(9) Inventory of Goods

Product shelves in stores may be observed at fixed points to detect the date and time when products are displayed, the number of times that customers pick up products, and products being sold out. In the apparel industry, for each piece of clothing, the number of times when a customer has picked up the clothing is measured, which may be effective in identifying popular products. Further, determination is made by using, as an abnormal condition, an act of putting a product in a customer's own bag, which probably enables detection of shoplifting.

(10) Assistance in Autonomous Driving

An autonomous vehicle recognizes external conditions by using a vehicle-mounted camera. However, only the vehicle-mounted camera is not sufficient in some cases. For example, if the leading vehicle of an autonomous vehicle is a truck with a high seating position, it is possible to erroneously recognize that the autonomous vehicle can move to a space under the truck. However, as long as the autonomous vehicle and the truck are photographed from above, when autonomous driving based on such erroneous recognition is carried out, the abnormality determination device 102 may send a control signal for instructing the autonomous vehicle to decelerate. In this way, the abnormality determination device 102 is also effective in assisting autonomous driving.

(11) Automatic Optimization of Supply Chain

The camera 104 can recognize from which warehouse a delivery vehicle departs and which route the delivery vehicle selects. The abnormality determination device 102 then may notify a plurality of delivery vehicles of an optimum route.

(12) Solution to Traffic Congestion

The abnormality determination device 102 may measure a change in traffic volume by fixed-point observation. The abnormality determination device 102 may secure safety by simultaneously transmitting a control signal for instructing speed limit to automobiles at a point where the traffic volume is large. In addition, some of the automobiles may be guided to a detour, or an optimum departure time may be notified to some of the automobiles before departure in view of traffic congestion.

What is claimed is:

1. An abnormality determination device comprising:
an imaging unit configured to capture a moving image;
an image recognition unit configured to extract, from the moving image, a plurality of still images that continues with time and identify an object that moves or changes with reference to the plurality of still images;
an abnormality determination unit configured to determine whether an abnormal condition is satisfied on a basis of an operation mode of the identified object; and
a notifying unit configured to notify an external device of occurrence of abnormality when the abnormal condition is satisfied.

2. The abnormality determination device according to claim 1, wherein the abnormality determination unit determines whether the abnormal condition is satisfied by inputting an operation mode of an object included in the captured moving image to an abnormality determination model that has performed supervised learning with a moving image when the abnormal condition is satisfied used as teacher data.

3. The abnormality determination device according to claim 1, wherein
the abnormal condition is a condition for defining dangerous driving by an automobile,
the image recognition unit identifies an automobile as the object with reference to the plurality of still images,
the abnormality determination unit determines whether an operation mode of the automobile included in the moving image satisfies the abnormal condition, and
the notifying unit sends a control signal to the automobile when the abnormal condition is satisfied.

4. The abnormality determination device according to claim 3, wherein the abnormality determination unit determines whether the abnormal condition is satisfied on a basis of a change in a positional relationship between a first object corresponding to a first automobile and a second object corresponding to a second automobile.

5. An abnormality determination program that causes a computer to execute:
a function of capturing a moving image;
a function of extracting, from the moving image, a plurality of still images that continues with time and identifying an object that moves or changes with reference to the plurality of still images;
a function of determining whether an abnormal condition is satisfied on a basis of an operation mode of the identified object; and
a function of notifying an external device of occurrence of abnormality when the abnormal condition is satisfied.
